(19) United States
(12) Patent Application Publication
(10) Pub. No.: US 2024/0259844 A1
(43) Pub. Date: Aug. 1, 2024

(54) GENERATING AND AGGREGATING DATA FOR NETWORK MONITORING

(71) Applicant: Telefonaktiebolaget LM Ericsson (publ), Stockholm (SE)

(72) Inventors: Attila BÁDER, Paty (HU); Gergely DÉVAI, Budapest (HU); Peter SCHVARCZ-FEKETE, Budapest (HU); Andras SOLYMOSI, Budapest (HU); Virag WEILER, Budapest (HU); József MALA, Cegled (HU)

(21) Appl. No.: 18/564,073

(22) PCT Filed: May 31, 2021
(86) PCT No.: PCT/EP2021/064550

§ 371 Date: Nov. 25, 2023

(51) Int. Cl. H04W 24/08; H04L 43/02; H04L 43/06

(52) U.S. Cl. CPC H04W 24/08; H04L 43/02; H04L 43/06

(57) ABSTRACT

We generally describe a method for generating key performance indicator data for network monitoring in a mobile telecommunication network. The method includes providing, relative to an event in the mobile telecommunication network, one or both of a first priority value of a key performance indicator and a second priority value of a key performance indicator dimension. The method further includes determining, based on one or both of the first priority value and the second priority value, whether to generate the key performance indicator data for the network monitoring in the mobile telecommunication network.

### TECHNICAL FIELD

The present disclosure generally relates to methods and apparatuses for generating and aggregating key performance indicator data for network monitoring in a mobile telecommunication network.

### BACKGROUND

In order to monitor and analyze service and/or network quality in particular on a subscriber level in a mobile telecommunication network, customer experience management (CEM) and/or subscriber analytics systems, which may be part of the network management domain, may be used. Generally, event-based subscriber analytics or CEM are used in service operation centers (SOCs) so as to monitor quality in particular of a wide variety of services which may be used on a network level. Furthermore, they may be used for monitoring the customer experience on an individual per subscriber level. Such systems are generally widely used in customer care and other business scenarios.

Advanced analytics systems may be based on collecting and correlating elementary network events from different core and radio nodes/network functions and interfaces. It may also allow for deriving end-to-end (e2e) service quality metrics based on these data. Event-based analytics may require real-time collection and correlation of characteristic node and protocol events from different radio and core nodes. It may further require probing signaling intelligent filtering (IF) and sampling of the user-plane traffic. Based on the correlated information call, session and service-related per user equipment (UE) session, elementary key performance indicators (KPIs) may be derived. Beside the data collection and correlation functions, the system may require advanced database, rule engine, and a big data analytics platform. These types of solutions may be suitable for session-based monitoring, troubleshooting and analysis of network issues.

CEM systems may also be used in network operation centers (NOC) for network monitoring optimization and troubleshooting. In these use cases, the per UE session KPIs may be aggregated in different time periods as well as for different node, network, service, subscriber, terminal, etc. dimensions. KPIs can be monitored in dashboards, but they are also input for an increasing number of automated network operation functions.

In these applications, the KPIs are continuously collected, aggregated for different dimensions and drilled down to the dimensioning instances. Examples are voice quality per terminal and subscription types, changing the call drop ratio per internet protocol multimedia core network subsystem (IMS) node instances, etc.

In view of the introduction of 5^{th} generation (5G) mobile networks, it is expected that mobile networks will serve (and provide quality of service, quality of experience) a large variety of new service types, and serve much higher number of devices or UEs than in previous network technologies. This will significantly increase the incoming event rate and type to be processed by network analytics systems as well as the required KPIs and KPI dimensions.

Event-based analytics system correlate events into per UE session records. In a nation-wide deployment, the number and volume of the per UE correlated session records is large. Therefore, it is not feasible to store, or store for a longer time these records.

### SUMMARY

Accordingly, there is a need for a technique that avoids the above drawbacks.

According to one aspect, a method for generating key performance indicator data for network monitoring in a mobile telecommunication network is provided. The method comprises providing, relative to an event in the mobile telecommunication network, one or both of a first priority value of a key performance indicator and a second priority value of a key performance indicator dimension. It is then determined, based on one or both of the first priority value and the second priority value, whether to generate the key performance indicator data for the network monitoring in the mobile telecommunication network.

In some examples, the method further comprises calculating or obtaining a combined priority value for a combination of the key performance indicator and the key performance indicator dimension. The combined priority value is based on the first priority value of the key performance indicator and the second priority value of the key performance indicator dimension. The determination whether to generate the key performance indicator data for the network monitoring in the mobile telecommunication network is based on the combined priority value.

In some examples, the key performance indicator dimension relates to a potential source of a network performance degradation measurable via the key performance indicator.

The key performance indicator dimension may comprise or relate to one or more network entities. In particular, the one or more network entities may comprise or relate to one or more of: one or more nodes in the network, one or more terminals in the network, one or more services provided in the network, and one or more subscribers in the network.

Generally, the key performance indicator dimension is, for example, a kind of network, subscriber, service etc. attribute or parameter of the key performance indicator. It may be one or more of a cell, a used radio technology frequency, a terminal type, a subscriber group, a service type, a used transport protocol, a network node, etc.

In some examples, the first priority value defines a first prioritization of a first said key performance indicator relative to a second said key performance indicator. Furthermore, the second priority value defines a second prioritization of a first said key performance indicator dimension relative to a second said key performance indicator dimension.

In some examples, the determination whether to generate the key performance indicator data is dependent on one or both of a processing capacity and a storage capacity in the mobile telecommunication network.

In some examples, the combined priority value is unique for each pair of key performance indicator and key performance indicator dimension.

In some examples, the key performance indicator data is generated when a time interval during which aggregated key performance indicator data (which may be aggregated into a database portion of a database) has reached a predefined accuracy threshold has elapsed. The time interval may, in some examples, be defined to be between a first boundary time interval and a second boundary time interval.

In some examples, the generated key performance indicator data is aggregated into a database portion of a database if the key performance indicator satisfies an accuracy condition.

In some examples, if the key performance indicator does not satisfy the accuracy condition, data relating to the combination is stored in the database outside the database portion and in a category common for combinations of different types of key performance indicators and key performance indicator dimensions for which the key performance indicator does not satisfy the accuracy condition.

In some examples, a storage time for storing the aggregated key performance indicator data in the database portion is dependent on a time resolution for aggregating the generated key performance indicator data into the database portion.

In some examples, if a storage limit in the mobile telecommunication network has been reached, the key performance indicator data aggregated into the database portion is deleted if the key performance indicator data was generated before a predefined point in time.

In some examples, the aggregation into the database portion for a plurality of combinations of key performance indicators and key performance indicator dimensions is performed in an order of the combined priority values of the respective combinations. It may start with the highest combined priority value amongst the combined priority values of the combinations.

In some examples, the aggregation is limited to the combination for which a frequency of the key performance indicator dimension being read is above a frequency threshold.

In some examples, an accuracy of the key performance indicator is expressed as a criterion for a confidence interval for the key performance indicator data. In particular, the confidence interval may be defined based on one or both of a z-distribution and a standard deviation for data collected for key performance indicators.

In some examples, an accuracy target for the key performance indicator is common for different key performance indicators.

In some examples, the combined priority value is a product of the first priority value and the second priority value.

In some examples, if a difference between the second priority value of the key performance indicator dimension relative to a first said key performance indicator and the second priority value of the key performance indicator dimension relative to a second said key performance indicator is above a difference threshold, the combined priority value for the combination of the key performance indicator dimension and the first key performance indicator and for the combination of the key performance indicator dimension and the second key performance indicator, respectively, is a corresponding, respective predefined, fixed combined priority value for each combination.

According to a further aspect, a method for aggregating key performance indicator data for network monitoring in a mobile telecommunication network is provided. The method comprises obtaining, relative to an event in the mobile telecommunication network, key performance indicator data relative to a combination of a key performance indicator and a key performance indicator dimension. The method further comprises determining or obtaining information of whether the combination or one of the key performance indicator and the key performance indicator dimension meets a predefined accuracy target. Based on whether the predefined accuracy target is met, the key performance indicator data is aggregated into or removed from a database storing key performance indicator data used for network monitoring in the mobile telecommunication network.

In some examples, the method comprises storing the key performance indicator data in the database irrespective of whether the predefined accuracy target is met. The key performance indicator data for which the predefined accuracy target is not met is removed once the database has been aggregated with at least a predefined amount of key performance indicator data for which the predefined accuracy target is met.

In some examples, the method further comprises using key performance indicator data for which the predefined accuracy target is not met for an aggregation process taking place over a first time period which is longer than a second time period for aggregating the key performance indicator data for which the predefined accuracy target is met.

In some examples, if the predefined accuracy target is not met at a first point in time, the method comprises waiting until the predefined accuracy target is met at a second point in time which is later than the first point in time. The key performance indicator data is aggregated into the database once the predefined accuracy target is met.

In some examples, an order of aggregating the key performance indicator data into the database is dependent on one or more of a first priority value of the key performance indicator, a second priority value of the key performance indicator dimension, and a combined priority value of the combination. The combined priority value is based on the first priority value and the second priority value.

In some examples, the key performance indicator data is generated based on the method of any one of the example implementations outlined throughout the present disclosure, and in particular based on the method of any one of the example implementations outlined above.

There is further provided a computer program product comprising program code portions that, when executed on at least one processor, configure the processor to perform the method of any one of the example implementations outlined throughout the present disclosure, and in particular based on the method of any one of the example implementations outlined above. In some examples, the computer program product is stored on a computer-readable recording medium or encoded in a data signal.

According to a further aspect, an apparatus for generating key performance indicator data for network monitoring in a mobile telecommunication network is provided. The apparatus is configured to provide or obtain, relative to an event in the mobile telecommunication network, one or both of a first priority value of a key performance indicator and a second priority value of a key performance indicator dimension. The apparatus is further configured to determine, based on one or both of the first priority value and the second priority value, whether to generate the key performance indicator data for the network monitoring in the mobile telecommunication network.

The apparatus is, in some examples, adapted to perform the method of any one of the example implementations outlined throughout the present disclosure, and in particular the method of any one of the example implementations outlined above.

According to a further aspect, an apparatus for aggregating key performance indicator data for network monitoring in a mobile telecommunication network is provided. The apparatus is configured to obtain, relative to an event in the mobile telecommunication network, key performance indicator data relative to a combination of a key performance indicator and a key performance indicator dimension. The apparatus is further configured to determine or obtain information of whether the combination or one of the key performance indicator and the key performance indicator dimension meets a predefined accuracy target. Furthermore, the apparatus is configured to aggregate or remove, based on whether the predefined accuracy target is met, the key performance indicator data into or from a database storing key performance indicator data used for network monitoring in the mobile telecommunication network. The apparatus may be comprised in or be identical to the apparatus outlined above regarding the generation of key performance indicator data for network monitoring in a mobile telecommunication network.

The apparatus is, in some examples, adapted to perform the method of any one of the example implementations outlined throughout the present disclosure, and in particular the method of any one of the example implementations outlined above.

### BRIEF DESCRIPTION OF THE DRAWINGS

Further aspects, details and advantages of the present disclosure will become apparent from the detailed description of exemplary embodiments below and from the drawings, wherein:

FIG. 1 is a schematic illustration of an architecture according to example implementations as described herein;

FIG. 2 shows a flow diagram of a process of aggregation according to example implementations as described herein;

FIG. 3 shows a flow diagram of a method according to example implementations as described herein;

FIG. 4 shows a schematic block diagram of an apparatus according to example implementations as described herein;

FIG. 5 shows a flow diagram of a method according to example implementations as described herein; and

FIG. 6 shows a schematic block diagram of an apparatus according to example implementations as described herein.

### DETAILED DESCRIPTION

In the following description, for purposes of explanation and not limitation, specific details are set forth in order to provide a thorough understanding of the present disclosure. It will be apparent to one of skill in the art that the present disclosure may be practiced in other embodiments that depart from these specific details.

While, for example, the following description focuses on an exemplary network configuration in accordance with 5G specifications, the present disclosure is not limited in this regard. The present disclosure could, for example, also be implemented in other cellular or non-cellular wireless communication networks, such as those complying with 4^{th} generation (4G) specifications (e.g., in accordance with the Long Term Evolution (LTE) specifications as standardized by the 3^{rd} Generation Partnership Project (3GPP)).

Those skilled in the art will further appreciate that the steps, services and functions explained herein may be implemented using individual hardware circuits, using software functioning in conjunction with a programmed microprocessor or general purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that perform the steps, services and functions disclosed herein when executed by the one or more processors.

In the following description of exemplary implementations, the same reference numerals denote the same or similar components.

The present disclosure generally relates to methods and apparatuses for generating and aggregating key performance indicator data for network monitoring in a mobile telecommunication network, in particular to provide for efficient aggregation for an analytics system used for network monitoring. Network monitoring may hereby comprise or relate to, for example, service and/or network quality monitoring.

The inventors have realized that applications may require pre-aggregated tables of the supported/required views because, due to the large amount of the data, on the fly query methods may take too long.

Data may be aggregated for different time periods and dimensions. The issue, which is addressed by the present disclosure, is that the combination of the KPIs and dimensions are large. Therefore, it may not be possible to support all KPIs for many dimensions and parameters. Especially for smaller dimensions, like cell, terminal types, service provider, etc., the number of instances may be high, thus leading to large aggregation tables. Generating these tables may therefore require high processing and storage capacity.

Another issue, which is addressed by the present disclosure, is that in network engineering, troubleshooting use cases require a fine-grained time resolution. This may further increase the processing and storage demand of the analytics solution, which issue is addressed by the present disclosure.

Oftentimes, data may need to be aggregated for multiple dimensions, which may further increase the granularity of aggregated data.

Due to the above issues, the number of KPIs and dimensions for which aggregations are configured may have to be strongly limited. For the users of the analytics system, it may appear that the system supports only few KPIs for a limited number of dimensions. However, the system collects events for much more KPIs and dimensions.

A further issue, which is addressed by the present disclosure, is that due to the small dimension instances and short aggregation times, there may be many KPI values in the aggregator tables which may be inaccurate or unreliable, due to the relatively low sample size. Processing and storing these data may not only require large hardware resources, but it may lead to wrong consequences and decisions in upper layer applications for which these aggregated data serve as input.

Partial data collection, filtering, and sampling are techniques to decrease the amount of data that the analytics system shall handle. However, these decrease the number of samples belonging to time slots and dimension instances in the different aggregation tables, therefore making these less accurate. It is non-trivial to determine the accuracy and required amount of data of these samples.

According to the present disclosure, an efficient automated aggregation method is described for an event-based analytics system, in which statistical methods may be used to identify one or more of KPIs, KPI dimensions and time resolutions that meet one or more predefined KPI accuracy criteria. In some examples, based on the priority of KPIs and KPI dimensions, only the highest priority aggregated tables may be generated and kept, which may have enough accurate data and fit into the available processing and storing capacity. In some examples, only those parts of the tables are kept which meet the accuracy targets.

The accuracy of aggregated data may, in some examples, primarily depend on the number of available data points that are aggregated. For this reason, it may happen that a lower time-resolution aggregation (e.g. 1 minute) produces (e.g. mostly) inaccurate aggregated values, but, if aggregated for a longer time period (e.g. 1 hour), the aggregates are (e.g. mostly) accurate-enough. The 1-hour aggregates can be computed from the original records or by aggregating the 1-minute aggregates—the result may be the same. For this reason, it may happen that aggregating inaccurate data results in accurate-enough data.

Regarding the policy to fill in certain tables, the goal may be that—in the long run-only those records are kept in a table that meet the accuracy target. Also—in the long run—only those tables may be kept, where the percentage of the accurate-enough (and thus kept) records reach a certain target (e.g. 50% or more). For the reasons outlined above (that is, aggregating inaccurate data can lead to accurate longer-time-period aggregates), the method may still store inaccurate records in a table or keep a table with accurate data percentage lower than the configured threshold for a limited amount of time, for the sake of providing input for longer-time-period aggregations. When the longer-time-period aggregation is completed, the inaccurate records are deleted from the shorter-time-period table, reaching the goal. However, this option is not the only possible solution: Inaccurate records can be streamed to the longer-time-period aggregation, in which case they may never be stored in the data base table. Yet another option is to keep the time interval of the aggregation flexible and wait until the record becomes accurate, and then write it into the database.

In some examples, the following input parameters may be defined for the system in view of current active use-cases: a list of required KPIs, priorities of KPIs; required dimensions for each KPI (which may, in some examples, be common for more or all KPIs), the priority of dimensions; required time resolutions; the target precision for the KPIs, and the preferred evaluation method; and the confidence level.

The use cases determine which KPIs and/or dimensions may be needed and what are the priorities. For example, one may want to check video quality KPI for a new terminal type. Video KPI and drill down to terminal types may be selected and the KPI value for the new other devices are compared. Alternatively or additionally, one may want to find cells where coverage is not sufficient with the same tool. This user drills down Reference Signal Received Power (RSRP) for cell dimension and ranks the results. For this user, the RSRP per terminal type may not be important, but e.g. video quality per cell may be useful but not a top priority.

Due to the large volume of data, one may not support these views by on demand queries. Aggregated tables for these KPI dimension combinations may need to be calculated. The number of the possible KPI and dimension combinations is large, and therefore, one cannot afford to calculate these tables for all combinations. It is instead done for the highest priority KPI and dimension combinations, which are needed for the use case(s).

During operation, the system may apply a suitable statistical method for each KPI type and determines the confidence interval for each KPI and dimension instances and requested aggregation periods. Based on predefined accuracy targets, the KPIS, dimensions and aggregation periods are determined for which there is not enough data. These tables may not be stored and indicated to the user. Only those tables may be generated and stored which have enough accurate data.

In some cases, for certain KPI, dimension and aggregation time combinations, the accuracy target is not fulfilled for a part of the dimension instances. These data are, in some examples, not added to the tables to save resources. Alternatively, these data are aggregated into a common other category (in the same database (but another database portion) and/or another database).

In some examples, based on the available or preconfigured processing and storing capacity, only the highest KPI and dimension combinations are generated and kept.

Using this smart filtering and sampling method, the problem coverage gaps may be minimized.

Alternatively, the time interval for specific dimension instances can be determined dynamically: The aggregated value is, in some examples, written as soon as the desired accuracy has been reached. Lower and upper bounds may be defined for the dynamically determined time periods.

The result of the process may be aggregated tables for the highest priority KPI and dimension combinations with the finest possible time resolution, filled with accurate KPI values.

The fine time granulated tables may be further aggregated for longer time periods. Aggregator tables are, in some examples, stored based on the configured retention strategy. Lower time resolution data may be stored for a longer period then finer-grained data. Oldest data may be removed when the configured storage limit is reached.

In some examples, as a secondary output of the method and calculation, the accuracy of the KPIs in each dimension, as well as the minimum aggregation time for which the target accuracy may be achieved, may be indicated in the presentation layer.

The analytics method and apparatus as described herein may calculate many KPIs from the correlated event records.

Each network function may send events related to active sessions. In the analytics system, one may have to correlate them to sessions. A session ID may not be available in the events. The correlation information may be the International Mobile Subscriber Identity (IMSI) and/or Subscription Permanent Identifier (SUPI) and the time stamp. In user plane records, only the destination internet protocol (IP) address may be available. Hence, one may have to map this to IMSI first in the correlator.

One of the main analytics of this is that these KPIs may be split for different dimension. For example, video quality KPI may be monitored, but for the analysis, one may want to see this KPI per cell or per terminal type. Here, the cell and terminal type may be called dimensions and the operation of splitting this KPI per dimension values may refer to drilling down of the video KPI to cell or terminal type dimension (both may be important dimensions).

Another KPI is for example the RSRP radio signal strength, which may be an important KPI in some use cases. RSRP per cell may be an important KPI dimension combination in some use cases, but the RSRP per terminal KPI may not be as important in some use cases, as an example. For example, a simple solution is a simple multiplication of the priority values of the KPI and KPI dimension. For example, KPI₁ may have a priority of 2, and KPI₂ may have a priority of 3, dimension₁ may have a priority of 4, and dimension₂ may have a priority of 5. Then, in some examples, KPI₁dimension₂ may have a priority of 10, and KPI₂dimension₁ a priority of 12. KPI₁dimension₂ has, in this example, a priority which is higher than the priority of KPI₂dimension₁ (assuming a lower number means a higher priority). Therefore, the combined priority may be taken into account in some examples.

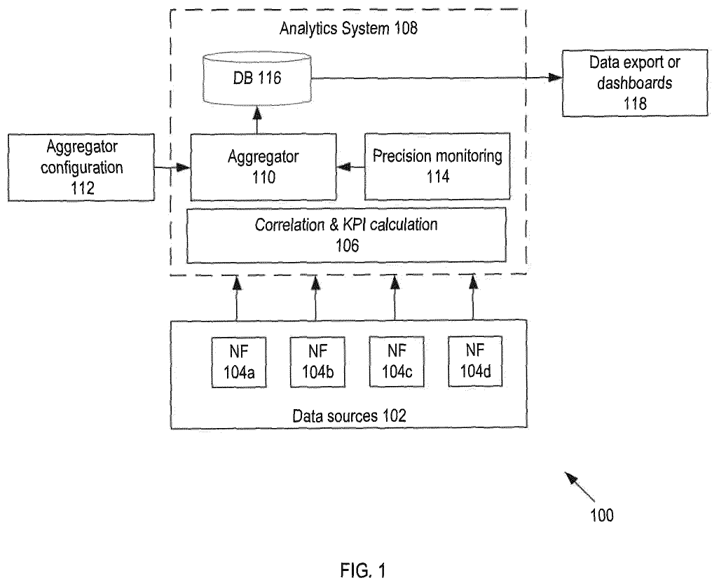

FIG. 1 is a schematic illustration of an architecture 100 according to example implementations as described herein.

In this example, data (such as, but not limited to KPIs, events) is collected from data sources 102, in this example network functions (NFs) 104a, 104b, 104c and 104d, in different network domains. As will be appreciated, data may be collected from a different number of NFs. The one or more NFs may comprise one or more of: a network entity, an application function (AF), a network exposure function (NEF), a session management function (SMF), a user plane function (UPF), a policy control function (PCF), a unified data management (UDM) entity, an access and mobility management function (AMF), a network repository function (NRF), a network slice selection function (NSSF), an authentication server function (AUSF), an internet protocol multimedia subsystem (IMS), a mobility management entity (MME), a serving gateway (SGW), a packet data network gateway (PGW), and others.

These data from the data sources 102 may be correlated in the correlation and KPI calculation module 106 of the analytics system 108.

The aggregator 110 receives an aggregator configuration 112, which describes which KPI(s) to aggregate for what time interval(s) and per which dimension(s).

Precision monitoring 114 keeps track of the number of KPIs available in the system for different time intervals and for dimension values. It also keeps track of the standard deviation of the KPIs. Based on this data, it computes the confidence intervals of the aggregated KPIs, according to the methods described below. These accuracy measures are then communicated to the aggregator 110.

The aggregator 110 computes the aggregated KPI values according to the configuration and decides which of these need to be stored in the database (DB) 116. This dynamic decision process is described in more detail below.

The KPI aggregates, stored in the database 116, are used, in this example, to serve queries from the graphical frontends of the analytics system 108 (e.g. dashboards 118) or are exported via bulk data export.

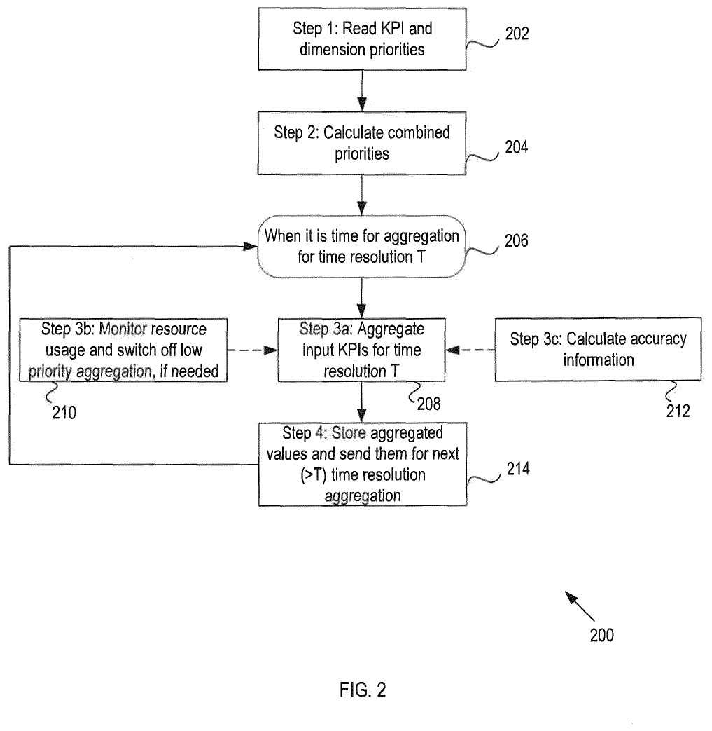

FIG. 2 shows a flow diagram of a process 200 of aggregation according to example implementations as described herein.

While details of the process 200 are outlined further below, the process 200 can be summarized as follows:

At step 1, configuration data (that is, KPI and dimension priorities) are read (202). At step 2, combined priorities are calculated (204). When it is time for aggregation for a time resolution T, at step 3, data is aggregated. In particular, at step 3a, the input KPIs are processed and the aggregated values are calculated (208). At step 3b, in order to enforce resource usage limits and the priorities from step 2, resource usage is monitored and low priority aggregation is switched off, if needed (210). At step 3c, accuracy information is calculated (212) so as to provide the accuracy of the aggregated values. At step 4, the accurate-enough aggregated values are stored and the values are propagated for further aggregation for the next time resolution aggregation (214).

The combined KPI and dimension priorities may be determined using different mathematical methods.

In case of limited processing and storing capacity, it may be desirable to generate and keep KPI dimensions (or dimension combinations) for the highest priority KPIs and drill downs. The priorities of the KPIs and the dimensions may be determined based on the required analytics use cases (202 in FIG. 2). The system may include a default priority, which can be modified by the user.

In some examples, at step 2 (204 in FIG. 2), the priorities of KPIs and dimensions (or dimension combinations) are determined independently from each other. For example, P_KPI₁ . . . P_KPIₙ may refer to the priorities of the KPIs, and P_D₁ . . . P_Dₘ may refer to the priorities of the dimensions. The combined KPI and dimension priority for KPI i and dimension j may be determined as P_KPI_Dᵢⱼ=P_KPIᵢ ∘P_Dⱼ (where ∘ relates to an operator for combining P_KPIᵢ and P_Dⱼ, the result of which is the combined priority value).

In some examples, if the priority of dimensions in relation to different KPIs are significantly different, P_KPI_D_{i,j} may be provided explicitly.

In either case, it may be that in some examples the overall priority of certain dimensions for a lower priority KPI are higher than certain dimensions for a higher priority KPI.

The combined priorities may be unique.

The aggregator 110 receives KPIs from the correlation and KPI calculation module 106 (in the following also just called “correlator”). The correlator typically calculates KPIs for a single session for the smallest aggregation time, e.g. 1 or 5 minutes. The correlator sends the event count, average and standard deviation for each KPIs as well as the parameter values of the KPI dimensions to the aggregator 110.

Aggregation of KPIs for different dimensions (step 3a (208) of FIG. 2) is performed in priority order, starting with the highest KPI and dimension combination priority, P_KPI_D_{i,j}.

In the time domain, different resolutions may be defined, such as 5 min, 1 hour, 1 day (but other resolutions may be chosen). These are typical values, shorter, e.g. 1 min, or longer, e.g. 1 week or 1 month, may be needed for certain use cases.

Processing and storage capacity limits may be configured for each time resolution. These may be enforced by step 3b (210) of FIG. 2.

First, the smallest time resolution aggregated tables may be populated in the priority order of the KPI dimension combinations. When calculating the aggregated KPI values for the different dimension instances, the confidence interval may also be calculated (step 3c, 212 of FIG. 2). The selected accuracy criteria may be checked. The goal may be to store only those aggregated values in the database 116 which are accurate enough. This may be achieved using the following three example solutions:

In a first example, each record may be stored in the database 116 regardless of the accuracy. When ready, the aggregation of the next (lower) time resolution may happen and these values may be read from the database 116 for further aggregation. For example, a 1-hour aggregation may takes twelve 5-minute values. When ready, the values that do not reach the predefined accuracy target may be deleted from the database 116. Optionally, all records of the KPI-dimension-time interval combination may be deleted if the ratio of the accurate-enough records is below a predefined target, such as, but not limited to, 0.5.

In a second example, only those records are stored in the database 116 that reach the predefined accuracy target. All records are sent to the next (lower) time resolution aggregation process via some channel different from the database 116 (Kafka topic, REST API call etc.). Optionally, the written records (or the whole table) may be deleted if the ratio of the accurate-enough records is below a predefined target, such as, but not limited to, 0.5.

In a third example, minimum and maximum time interval values are defined for each time resolution level. For example, instead of fixed 5-minute, the range 1-min to 15-mins may be defined. Dynamic aggregation may be used, which stores aggregated records as soon as the accuracy target is reached (and the time interval is within the defined range). The details of this method are described further below.

When a capacity limit configured for a given time resolution has been reached, aggregated tables for more KPI or dimension may not be created.

The same process may be followed in lower time resolution as well. It may be expected that due to the larger sample size, the number of KPI and dimension combination with enough accurate data will be higher. On the other hand, considering a given time period, the number of tables for a KPI-dimension combination may be higher in case of higher time resolution. In some examples, it is desirable to set the capacity limits for the different time resolutions in a way which ensures the following: if an aggregated table for a KPI-dimension combination is generated and stored at a specific time resolution, it may be generated and stored at lower time resolution as well.

As a result, the highest priority KPI and dimension combinations may be available with the finest possible time resolution.

In order to save hardware resources for more KPI dimension combinations, the dimension values may be limited to the most frequent, highest or lowest values. In this case, the KPI values for the most frequent terminals, services, etc. may be available.

As an optional solution, the aggregations for which there are not enough data may be aggregated into one common category, which may called, e.g., “other”. The advantage of this solution compared to dropping these data is that the number of samples do not change during the aggregation. Therefore, the data normalization may be easier. Otherwise, the amount of dropped data may be recorded and taken into account during the normalization.

In a dynamic aggregation, each time resolution may be characterized by a time range. For example, instead of a fixed 5-minute time resolution, one may use the range 1-min (lower boundary) to 15-mins (upper boundary). Each aggregated value for such a time resolution may cover a time interval that falls in the defined range and may be shortest that meets the accuracy target. The schema of such an aggregated table may be as follows (for a selected KPI, dimension and minimum time resolution): start timestamp; end timestamp; dimension value; KPI sum; KPI count.

For each record, the difference of the “end timestamp” and the “start timestamp” is within the time resolution range.

The algorithm to fill in such a table with aggregated values is as follows.

It is assumed that the records arrive in a correct order:

```
For all dimension values v:
  - start timestampᵥ := current timestamp
  - sumᵥ := 0
  - countᵥ := 0
Repeat forever:
  - r := next raw data record
  - v := dimension value of r
  - t : = timestamp of r
  - sumᵥ += kpi value of r; countᵥ += 1
  - if t - start timestamp within the range AND accuracy goal is met:
```

| | |
|---|---|
| ▪ | write out (start timestamp, t, sumᵥ, countᵥ) to database and |
| | pass it to the next (lower) time resolution aggregation pro- |
| | cess |
| ▪ | start timestampᵥ := t |
| ▪ | sumᵥ := 0; countᵥ := 0 |

- else if accuracy goal is NOT met AND t - start timestamp > upper
bound:

| | |
|---|---|
| ▪ | pass the aggregated value for the next (lower) time resolu- |
| | tion aggregation process |
| ▪ | start timestampᵥ := t |
| ▪ | sumᵥ := 0; countᵥ := 0 |

The evaluation of the accuracy goal is performed based on the sample count and other statistical properties of the data points, as will be described below.

Passing the record to the next (lower) time resolution aggregation process can happen as described above:
Write out the record to the database (regardless of the accuracy) and let the other process read it from there and delete inaccurate ones.
Write only accurate records and use a communication channel different from the database to pass the records.

The same algorithm can be used to compute aggregates with a longer minimal time interval. In those cases, the “next raw data record” is read from the finer-grained time resolution database table or received from the other communication channel used. The timestamp of the record becomes the start timestamp.

In the calculation of the KPI accuracy, the accuracy of a KPI is expressed as a criterion for the confidence interval. The confidence interval for full—in which the analytics tool receives events for all active sessions. This is a large load, and large hardware requirements are needed—and partial—which may relate to random sampling at the data sources and only, for example, 10 or 20% of sessions are monitored, whereby the aggregated KPI values are calculated based on these random samples—data collection is estimated based on the following methods/formulas.

In a first method, the confidence interval for counts is taken into account. Count like KPIs, like subscriber number, number of call setups, drops, etc., are assumed to follow the Poisson process and the lower and upper value of the confidence interval (CI) of the total counts is estimated at 1−α confidence level as:

$${CI}_{high} , {CI}_{l o w} : {( \frac{{z}_{α / 2}^{2} \sqrt{\frac{1 - p}{p}} \pm \sqrt{{z}_{α / 2}^{2} \frac{1 - p}{p} + \frac{4 n}{p}}}{2} )}^{2}$$

where n is the number of the collected data, p is the sampling ratio, in case of partial data, and z indicates the z distribution.

The confidence interval is CI=CI_{high}−CI_{low}, which falls back to

$$CI = 2 {z}_{α / 2} \sqrt{n}$$

in case of full data collection.

In a second method, the confidence interval for a mean value is taken into consideration. For determining the confidence interval for the average of ratio and gauge type KPIs, the central limit theorem is applied and the known formula is used:

$$CI = 2 {z}_{α / 2} {s}_{n} / \sqrt{n}$$

where sₙ is the corrected standard deviation of the samples, and n is the sample size.

Gauge may be a kind of physical measure, like a signal strength, RSRP, measured in, e.g., dBm, the signal-to-interference-plus-noise ratio (SINR) measured in, e.g., dB, or a setup time measured in, e.g., ms. It may be different from a counter, like number of call setups, or drop ratio.

When determining the confidence interval for a finite population, where the goal is to determine the mean value of a finite population consisting of N samples, the confidence interval is estimated as

$$CI = 2 {z}_{α / 2} {s}_{n} \qquad \sqrt{\frac{N - n}{n ( N - 1 )}}$$

There are different options for determining common criteria of the confidence interval. In order to simplify the system configuration, it may be desirable to apply the same criterion for multiple KPIs.

In a first option, the KPI mean may be taken into account. The confidence interval is smaller than a predefined ratio of the mean (x̅). This ratio is denoted by λ.

$$CI / \overline{x} < λ$$

For example, λ=0.05 or 0.1.

In a second option, the KPI range may be taken into account. In this method, the confidence interval is compared to a value range of the KPI. This value range can be the technically possible range of the given KPI, or a value range that is determined by the measured KPI values, e.g. a value range in which 95% of data falls. In this case the target criterion is formulated as

$$CI / R < λ$$

where R is the width of the KPI value range.

In a third option, the standard deviation may be taken into account. In this method, the confidence interval is compared to the standard deviation of the samples:

$$CI < {s}_{n} / k$$

where k is a predefined factor, e.g. k=4.

In a fourth option, the minimum number of the sample size may be taken into account. A very simple common criterion for multiple or all KPIs can be a fixed minimum number of sample. In this case, the target criterion is independent from the CI and formulated as:

$$N > {n}_{min}$$

where nₘᵢₙ is a predefined number, e.g. nₘᵢₙ=29. In this case, those KPIs are considered accurate which are based on at least 30 samples.

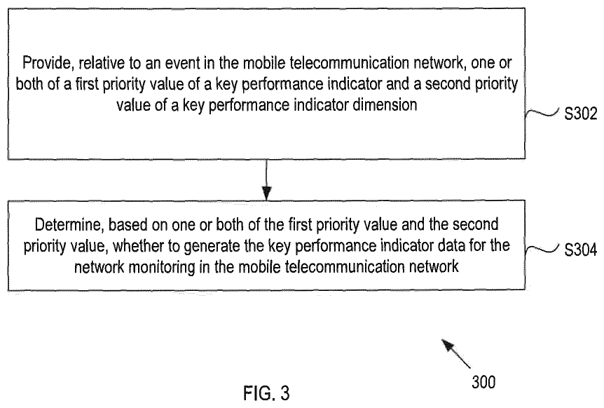

FIG. 3 shows a flow diagram of a method 300 according to example implementations as described herein.

In this example, the method 300 comprises providing (or obtaining), at step S302, relative to an event in the mobile telecommunication network, one or both of a first priority value of a key performance indicator and a second priority value of a key performance indicator dimension. At step S304, it is determined, based on one or both of the first priority value and the second priority value, whether to generate the key performance indicator data for the network monitoring in the mobile telecommunication network.

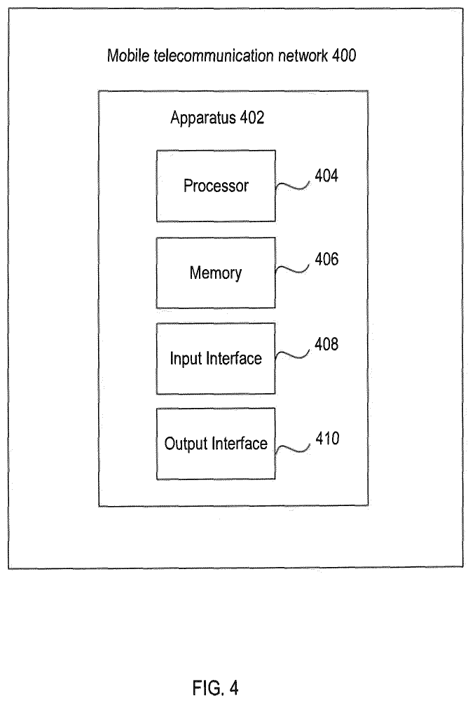

FIG. 4 shows a schematic block diagram of an apparatus 402 in a mobile telecommunication network 400 according to example implementations as described herein.

In this example, the apparatus 402 comprises a processor 404 operably coupled to a memory 406. An input interface 408 and an output interface 410 are respectively provided in order for the apparatus to receive and output data.

The memory 406 may store one or more program code portions, which, when executed by the processor 404, cause the processor 404 to provide or obtain, relative to an event in the mobile telecommunication network 400, one or both of a first priority value of a key performance indicator and a second priority value of a key performance indicator dimension; and determine, based on one or both of the first priority value and the second priority value, whether to generate the key performance indicator data for the net-work monitoring in the mobile telecommunication network 400.

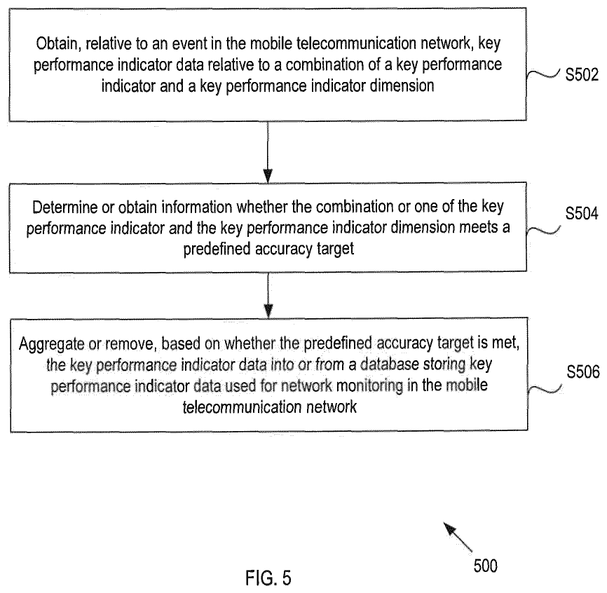

FIG. 5 shows a flow diagram of a method 500 according to example implementations as described herein.

In this example, the method 500 comprises obtaining, at step S502, relative to an event in the mobile telecommunication network, key performance indicator data relative to a combination of a key performance indicator and a key performance indicator dimension. At step S504, it is determined or information is obtained whether the combination or one of the key performance indicator and the key performance indicator dimension meets a predefined accuracy target. At step S506, based on whether the predefined accuracy target is met, the key performance indicator data is aggregated into or removed from a database storing key performance indicator data used for network monitoring in the mobile telecommunication network.

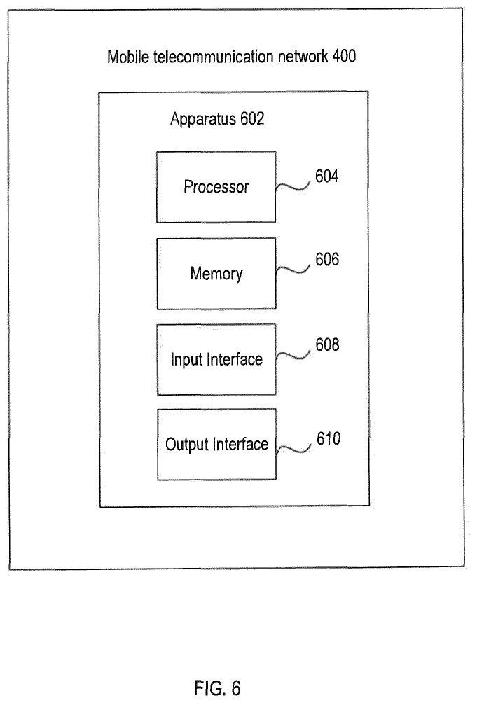

FIG. 6 shows a schematic block diagram of an apparatus 602 in a mobile telecommunication network 400 according to example implementations as described herein. The apparatus 602 may be comprised in or identical to the apparatus 402, and the apparatus 602 and the apparatus 402 may be in the same mobile telecommunication network 400.

In this example, the apparatus 602 comprises a processor 604 operably coupled to a memory 606. An input interface 608 and an output interface 610 are respectively provided in order for the apparatus 602 to receive and output data.

The memory 606 may store one or more program code portions, which, when executed by the processor 604, cause the processor 604 to obtain, relative to an event in the mobile telecommunication network 400, key performance indicator data relative to a combination of a key performance indicator and a key performance indicator dimension; determine or obtain information of whether the combination or one of the key performance indicator and the key performance indicator dimension meets a predefined accuracy target; and aggregate or remove, based on whether the predefined accuracy target is met, the key performance indicator data into or from a database storing key performance indicator data used for network monitoring in the mobile telecommunication network 400.

The processor 604 may be comprised in or identical to the processor 404. Additionally or alternatively, the memory 606 may be comprised in or identical to the memory 406. Additionally or alternatively, the input interface 608 may be comprised in or identical to the input interface 408. Additionally or alternatively, the output interface 610 may be comprised in or identical to the output interface 410.

The aggregation method, apparatus and system according to example implementations as described herein, which generate and store aggregation times in the order of KPI and dimensioning priorities, estimate the accuracy of the aggregated KPI values for different time periods and dimensions. Aggregated tables are generated and stored, which contain enough accurate values. Only those parts of the tables are generated and stored which are accurate, taking into account the accuracy targets.

The combined prioritization method of the KPIs and dimensions allows for ensuring that the most important KPI and dimension combinations are generated and stored.

The method, apparatus and system as described herein, using the accuracy criteria and KPI calculation methods, in which the calculation method may be applied for full and/or partial data collection, allow for data accuracy being checked, whereby inaccurate data may not be generated and/or stored, thereby saving significant processing and storing capacity. Different target criteria may be used for evaluating the accuracy of aggregated values.

Using a common accuracy criterion for multiple KPIs may simplify the configuration.

The finest time resolution for the different KPI and dimension combinations may be obtained. A flexible time resolution method and determining the minimum required time aggregation within a time period to meet KPI accuracy target may be used.

The described methods, apparatuses and systems ensure the efficient operation of network and subscriber analytics system in engineering use cases. It allows monitoring and troubleshooting a large number of KPIs in combination with many dimensions.

The prioritization method may ensure that the most important KPI and dimension combinations are generated and stored, taking into account the available storage and processing capacity. Using this smart filtering and sampling method, the problem coverage gaps can be minimized. In some examples, the priorities are determined for KPI and dimension combinations based on the priorities of KPIs and/or priorities of the dimensions.

The method allows generating tables with the finest possible time and dimension resolution. The optimum aggregation time can be automatically determined for different period ranges, e.g. 1-15 min, 1-3 h, 1-3 days, etc.

The data accuracy is checked, inaccurate data are not generated and/or stored, saving significant processing and storing capacity. At the same time, the method guarantees data accuracy.

The accuracy calculation methods are expressed in closed formulas, allowing quick and resource efficient evaluation. The formulas are determined and applicable both for full and/or partial data collection.

Common accuracy targets and methods are specified for multiple KPIs, simplifying system configuration and KPI comparison.

It will be appreciated that the present disclosure has been described with reference to exemplary embodiments that may be varied in many aspects. As such, the present invention is only limited by the claims that follow.

1. A method for generating key performance indicator data for network monitoring in a mobile telecommunication network, wherein the method comprises:
providing, relative to an event in the mobile telecommunication network, one or both of a first priority value of a key performance indicator and a second priority value of a key performance indicator dimension; and
determining, based on one or both of the first priority value and the second priority value, whether to generate the key performance indicator data for the network monitoring in the mobile telecommunication network.

2. A method as claimed in claim 1, further comprising:
calculating or obtaining a combined priority value for a combination of the key performance indicator and the key performance indicator dimension, wherein the combined priority value is based on the first priority value of the key performance indicator and the second priority value of the key performance indicator dimension, and wherein said determining whether to generate the key performance indicator data for the network monitoring in the mobile telecommunication network is based on the combined priority value.

3. A method as claimed in claim 1, wherein the key performance indicator dimension relates to a potential source of a network performance degradation measurable via the key performance indicator.

4. A method as claimed in claim 1, wherein the key performance indicator dimension comprises or relates to one or more network entities, in particular one or more of: one or more nodes in the network, one or more terminals in the network, one or more services provided in the network, and one or more subscribers in the network.

5. A method as claimed in claim 1, wherein the first priority value defines a first prioritization of a first said key performance indicator relative to a second said key performance indicator, and wherein the second priority value defines a second prioritization of a first said key performance indicator dimension relative to a second said key performance indicator dimension.

6. A method as claimed in claim 1, wherein the determination whether to generate the key performance indicator data is dependent on one or both of a processing capacity and a storage capacity in the mobile telecommunication network.

7. A method as claimed in claim 2, wherein the combined priority value is unique for each pair of key performance indicator and key performance indicator dimension.

8. A method as claimed in claim 2 wherein the key performance indicator data is generated when a time interval during which aggregated key performance indicator data has reached a predefined accuracy threshold has elapsed.

9. A method as claimed in claim 8, wherein the time interval is defined to be between a first boundary time interval and a second boundary time interval.

10. A method as claimed in claim 1, wherein the generated key performance indicator data is aggregated into a database portion of a database if the key performance indicator satisfies an accuracy condition.

11. A method as claimed in claim 10, wherein, if the key performance indicator does not satisfy the accuracy condition, data relating to the combination is stored in the database outside the database portion and in a category common for combinations of different types of key performance indicators and key performance indicator dimensions for which the key performance indicator does not satisfy the accuracy condition.

12. A method as claimed in claim 10, wherein a storage time for storing the aggregated key performance indicator data in the database portion is dependent on a time resolution for aggregating the generated key performance indicator data into the database portion.

13. A method as claimed in claim 10, wherein, if a storage limit in the mobile telecommunication network has been reached, the key performance indicator data aggregated into the database portion is deleted if the key performance indicator data was generated before a predefined point in time.

14. A method as claimed in claim 10, wherein the aggregation into the database portion for a plurality of combinations of key performance indicators and key performance indicator dimensions is performed in an order of the combined priority values of the respective combinations, starting with the highest combined priority value amongst the combined priority values of the combinations.

15. A method as claimed in claim 10, wherein the aggregation is limited to a said combination for which a frequency of the key performance indicator dimension being read is above a frequency threshold.

16. A method as claimed in claim 10, wherein an accuracy of the key performance indicator is expressed as a criterion for a confidence interval for the key performance indicator data.

17. A method as claimed in claim 16, wherein the confidence interval is defined based on one or both of a z-distribution and a standard deviation for data collected for key performance indicators.

18. A method as claimed in claim 1, wherein an accuracy target for the key performance indicator is common for different key performance indicators.

19. A method as claimed in claim 2 wherein the combined priority value is a product of the first priority value and the second priority value.

20. A method as claimed in claim 2, wherein, if a difference between the second priority value of the key performance indicator dimension relative to a first said key performance indicator and the second priority value of the key performance indicator dimension relative to a second said key performance indicator is above a difference threshold, the combined priority value for the combination of the key performance indicator dimension and the first key performance indicator and for the combination of the key performance indicator dimension and the second key performance indicator, respectively, is a corresponding, respective predefined, fixed combined priority value for each combination.

21.-32. (canceled)
